(19) United States
(12) Patent Application Publication
(10) Pub. No.: US 2026/0185782 A1
(43) Pub. Date: Jul. 2, 2026

(54) SPARK PLASMA BONDING OF ALUMINUM AND OTHER MATERIALS

(71) Applicant: ThermAvant Technologies, LLC, Columbia, MO (US)

(72) Inventors: Shane Hilsenbeck, Columbia, MO (US); Lily Ellebracht, Harrisburg, MO (US)

(21) Appl. No.: 19/430,622

(22) Filed: Dec. 23, 2025

Related U.S. Application Data
(60) Provisional application No. 63/738,925, filed on Dec. 26, 2024.

(51) Int. Cl. F28D 15/02; B23K 11/00; B23K 11/30; C22F 1/00; C22F 1/04; F28F 21/08

(52) U.S. Cl. CPC F28D 15/0283; B23K 11/0006; B23K 11/3009; F28F 21/084; C22F 1/002; C22F 1/04; F28F 2275/062

(57) ABSTRACT

A method of bonding two or more substrates, where the method comprises placing two or more substrates in a vacuum chamber, generating a vacuum in the vacuum chamber, compressing the substrates between opposing electrodes of a spark plasma bonding system to apply a target compression pressure, applying electrical current through the substrates via the electrodes to generate localized Joule heating, and maintaining the target compression pressure, a target bonding temperature for a target time duration sufficient to effect bonding between the substrates.

### CROSS-REFERENCE TO RELATED APPLICATIONS

This application claims the benefit of U.S. Provisional Application No. 63/738,925, filed on Dec. 26, 2024, the disclosure of which is incorporated herein by reference in its entirety.

### FIELD

The present teachings relate to techniques for bonding two aluminum surfaces together, and more particularly to a method for bonding adjacent substrates of an oscillating heat pipe (OHP) together without the occurrence of oxidization using spark plasma sintering (SPS).

### BACKGROUND

The statements in this section merely provide background information related to the present disclosure and may not constitute prior art.

Aluminum is very reactive to oxygen and rapidly forms a stable, tenacious surface oxide passivation layer that acts as a barrier to bonding. Brazing overcomes this issue by either using flux to remove the surface oxide (atmospheric brazing) or by using oxygen getters (like magnesium) under vacuum (vacuum brazing) prior to elevated temperature bonding with lower melting point alloys to form the requisite bond. However, atmospheric brazing is not an option for aluminum alloys containing magnesium, since the flux is poisoned by the magnesium. Furthermore, vacuum brazing is a slow, batch process that can require 12-24 hours for a single cycle due to ramping and cooling rates.

Diffusion bonding is another well-known metal bonding process that faces the same surface oxide barrier challenge. Pathways to overcoming the oxide barrier include deforming to break the barrier, low melting interlayers to dissolve the oxide, and oxide removal in an oxygen-free environment. Each of these approaches has difficulties. Deformation to break the oxide layer can collapse or damage internal structures of the part. Common interlayer materials also have issues, e.g., copper forms a brittle intermetallic, zinc is not vacuum compatible, and silver is very expensive to use. Oxide removal via polishing or abrading is a very common practice, but the oxide layer will rapidly re-form during the transfer to the furnace.

### SUMMARY

The present disclosure provides a bonding method referred to herein as spark plasma bonding (SPB) to overcome the above shortcoming of known bonding methods. More particularly, in various embodiments the present disclosure provides a method for bonding adjacent aluminum substrates of an oscillating heat pipe (OHP), or other device, together without the occurrence of oxidization using a spark plasma boding (SPB) system and method disclosed herein. Generally, SPB uses an electrical current that is passed through the aluminum substrates to accelerate the bonding process between the aluminum substrates via localized Joule heating at higher resistance gaps between the unbonded layers. Due to the localized heating, the processing time is significantly shorter than either diffusion bonding or vacuum brazing, which enables fast cycle times. The system and method of the present disclosure are referred to as SPB because the surfaces are directly bonded together via the Joule heating. The localized surface-current effect helps to additionally breakdown the oxide layer, in conjunction with the process that occurs in brazing. The SPB disclosed herein can be accomplished via direct bonding of the substrate surfaces or with the inclusion of any form of alloy interlayer such as foil, clad or deposited layers disposed between the substrates.

A method of bonding two or more substrates, where the method comprises placing two or more substrates in a vacuum chamber, generating a vacuum in the vacuum chamber, compressing the substrates between opposing electrodes of a spark plasma bonding system to apply a target compression pressure, applying electrical current through the substrates via the electrodes to generate localized Joule heating, and maintaining the target compression pressure, a target bonding temperature for a target time duration sufficient to effect bonding between the substrates.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### BRIEF DESCRIPTION OF DRAWINGS

The drawings described herein are for illustration purposes only and are not intended to limit the scope of the present teachings in any way.

FIG. 1 exemplarily illustrates a spark plasma bonding (SPB) system having a press actuator mechanism thereof in a Home position within an interior space of a vacuum chamber thereof, in accordance with various embodiments of the present disclosure.

FIG. 2 exemplarily illustrates the SPB system shown in FIG. 1 having a top ram of a press actuator mechanism partially extended, in accordance with various embodiments of the present disclosure.

FIG. 3 exemplarily illustrates the SPB system shown in FIG. 1 having a bottom ram of the press actuator mechanism partially extended, in accordance with various embodiments of the present disclosure.

FIG. 4 exemplarily illustrates the SPB system shown in FIG. 1 having a top ram and a bottom ram of a press actuator mechanism partially extended, in accordance with various embodiments of the present disclosure.

FIG. 5 is a flow chart exemplarily illustrating the SPB process/method, in accordance with various embodiments of the present disclosure.

FIG. 6 is an exemplary illustration of double-stacked parts after being placed in the SPB system in accordance with various embodiments of the present disclosure.

FIG. 7 is an exemplary illustration of single-stacked part after being placed in the SPB system in accordance with various embodiments of the present disclosure.

It should be understood that any or all of the features, functions and and/or method steps illustrated in each respective figure can be readily and easily combined with any or all of the features, functions and/or method step illustrated in one or more of the other figures to describe, generate and exemplarily illustrate various embodiments of the present invention that are described and/or claimed herein, and such embodiments would be readily and easily understood by one skilled in the art without the need for exemplary illustrations of such embodiments whose features, functions and/or method steps are clearly described and illustrated in the combination of the various figures.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

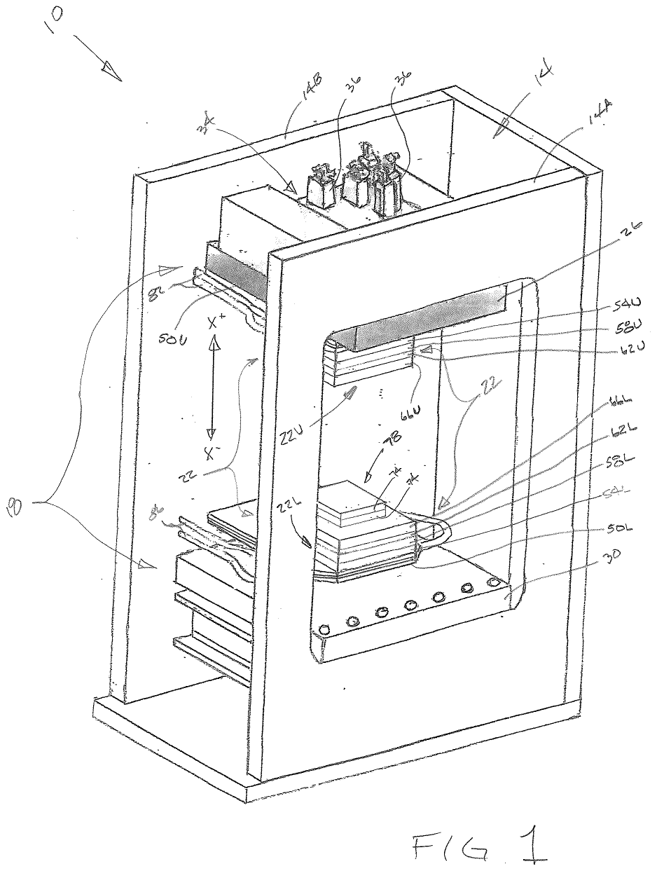

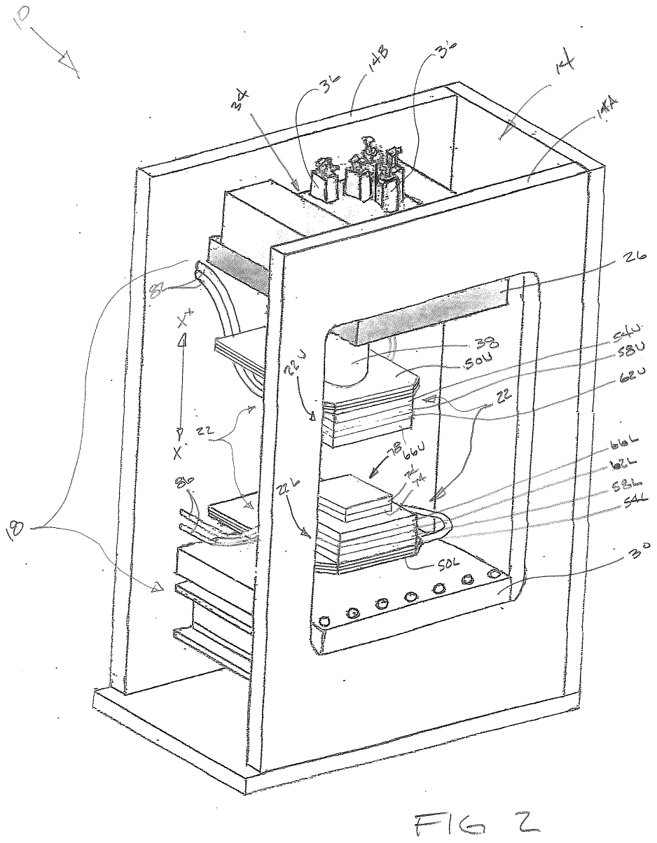

Referring to FIGS. 1 and 2, in accordance with various embodiments, the present disclosure provides a spark plasma bonding (SPB) system 10. The SPB system 10 is a low voltage, current activated, pressure-assisted bonding system for bonding two or more surfaces together using current heating (Joule heating) as described herein. The SPB system 10 generally comprises a vacuum chamber 14, a high pressure press assembly 18 disposed within the vacuum chamber, and a spark plasma electrical heating system 22 fixed to the high pressure press assembly 18. The vacuum chamber 14 can be any vacuum chamber sized to accommodate the high pressure press assembly 18 and the spark plasma electrical heating system 22 within an interior space thereof, and structured and operable to be generate an oxygen-free environment in which two or more surfaces can be SPB bonded together.

The high-pressure press assembly 18 comprises an upper plate 26 securely mounted to at least a front wall 14A and a back wall 14B of the vacuum chamber 14, a lower plate 30 securely mounted to at least the front wall 14A and the back wall 14B of the vacuum chamber 14, and a press actuator mechanism 34. The press actuator mechanism 34 can be a hydraulic assembly, a pneumatic assembly or an electrical assembly. For purposed of example, the press actuator mechanism 34 will be exemplarily described herein as being a hydraulic assembly. In various embodiments, the press actuator mechanism 34 can comprise one or more hydraulic valve 36 (sometimes referred to herein as upper hydraulic valves 36) mounted to an exterior side of the upper plate 26 (i.e., the said facing the exterior environment of the vacuum chamber 14) and an actuator ram 38 (sometimes referred to herein as the upper actuator ram 38). The actuator ram 38 is disposed within and extending through an opening (not shown) in the upper plate 26 such that, via a flow of hydraulic fluid controlled by the hydraulic valve(s) 36, the actuator ram 38 can be controllably moved in the X⁺ and the X⁻ directions.

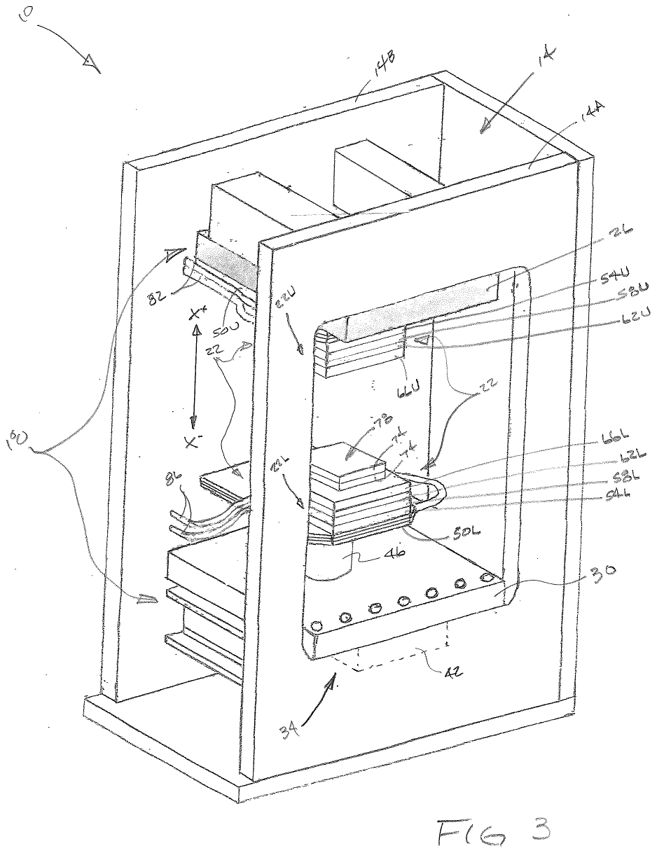

Referring to FIGS. 1 and 3, in various other embodiments, the press actuator mechanism 34 can comprise hydraulic valve(s) 42 (sometimes referred to herein as lower hydraulic valves 42) (shown in phantom block form in FIG. 3) mounted to an exterior side of the lower plate 30 (i.e., the side facing the exterior environment of the vacuum chamber 14) and the actuator ram 46 (sometimes referred to herein as the lower actuator ram 46) can be disposed within and extending through an opening (not shown) in the lower plate 30. In such embodiments, via a flow of hydraulic fluid controlled by the hydraulic valve(s) 42, the actuator ram 46 can be controllably moved in the X⁺ and the X⁻ directions.

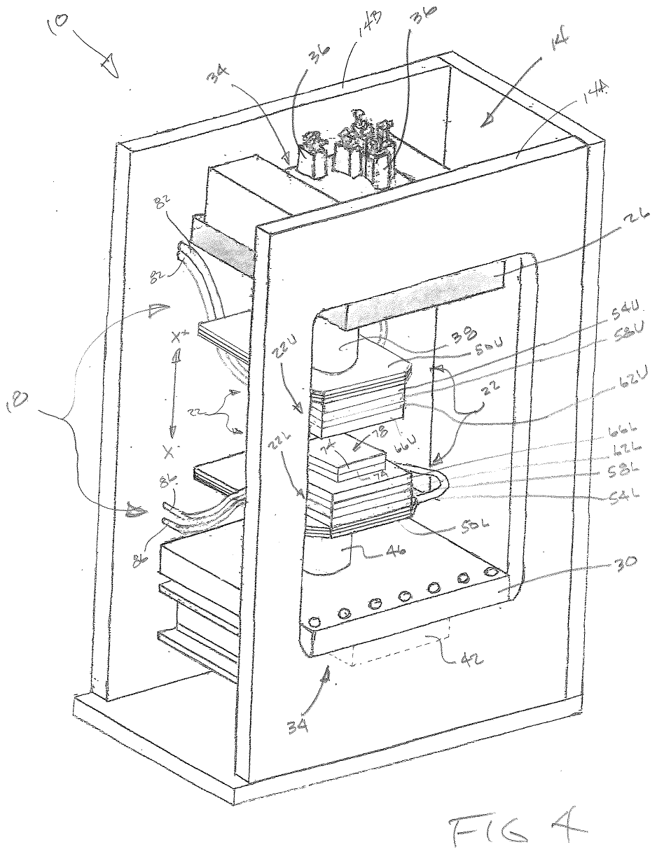

Referring to FIGS. 1 and 4, in yet other embodiments, the press actuator mechanism 34 can comprise the upper hydraulic valve(s) 36 mounted to an exterior side of the upper plate 26, the upper actuator ram 38 disposed within and extending through an opening (not shown) in the upper plate 26, the lower hydraulic valve(s) 42 mounted to an exterior side of the lower plate 30, and the lower actuator ram 46 disposed within and extending through an opening (not shown) in the lower plate 30. In such embodiments, via a flow of hydraulic fluid controlled by the upper and lower hydraulic valve(s) 36 and 42 the upper and lower actuator rams 38 and 46, can be independently and/or simultaneously controllably moved toward and away from each other in the X⁺ and the X⁻ directions.

For simplicity and clarity, the press actuator mechanism 34 will be exemplarily described herein with reference to the embodiments wherein the press actuator mechanism 34 comprises the upper hydraulic valve(s) 36 mounted to the exterior side of the upper plate 26 and the upper actuator ram 38 disposed within and extending through an opening in the upper plate 26.

Referring now to FIGS. 1, 2, 3 and 4, in various embodiments, the spark plasma electrical bonding system 22 comprises an upper electrical heating assembly 22U and a lower electrical heating assembly 22L. As exemplarily illustrated in FIG. 2, in various embodiments the upper electrical heating assembly 22U is removably mounted to a distal end of the upper ram 38 and the lower heating assembly 22L is removably mounted to the lower plate 30. In various other embodiments, as exemplarily illustrated in FIG. 3, the upper electrical heating assembly 22U is removably mounted to the upper plate 26 and the lower heating assembly 22L is removably mounted to a distal end of the lower ram 46. In yet other embodiments, as exemplarily illustrated in FIG. 4, the upper electrical heating assembly 22U is removably mounted to the distal end of the upper ram 38 and the lower heating assembly 22L is removably mounted to a distal end of the lower ram 46.

The upper electrical heating assembly 22U comprises: 1) an upper insulating spacer plate 50U removably mounted to the distal end of the upper ram 38 (FIGS. 2 and 4) or removably mounted to the upper plate 26 (FIG. 3); 2) a first upper electrode 54U (e.g., a brass electrode) stacked on and removably mounted to the upper insulating spacer plate 50U; 3) an upper exchange plate 58U stacked on and removably mounted to the first upper electrode 54U; 4) an upper carbon fiber composite (CFC) shield 62U stacked on and removably mounted to the upper exchange plate 58U; and 5) a second upper electrode 66U (e.g., a graphite electrode) stacked on and removably mounted to upper CFC shield 62U. Additionally, in various embodiments, the upper electrical heating assembly 22U comprises an upper cooling tube 70U (e.g., a copper cooling tube) that is disposed around and/or extending through the upper insulating spacer plate 50U. Similarly, the lower electrical heating assembly 22L comprises: 1) an lower insulating spacer plate 50L removably mounted to the lower plate 30 (FIG. 2) or removably mounted to the distal end of the lower ram 46 (FIGS. 3 and 4); 2) a first lower electrode 54L (e.g., a brass electrode) stacked on and removably mounted to the lower insulating spacer plate 50L; 3) a lower exchange plate 58L stacked on and removably mounted to the first lower electrode 54L; 4) a lower carbon fiber composite (CFC) shield 62L stacked on and removably mounted to the lower exchange plate 58L; and 5) a second lower electrode 66L (e.g., a graphite electrode) stacked on and removably mounted to lower CFC shield 62L. Additionally, in various embodiments, the lower electrical heating assembly 22L comprises a lower cooling tube 70L (e.g., a copper colling tube) that is disposed around and/or extending through the lower insulating spacer plate 50L.

It is envisioned that in various embodiments, the upper electrical heating assembly 22U and/or the lower electrical heating assembly 22L can have the first upper electrode 54U and/or the first lower electrode 54L omitted and remain within the scope of the present disclosure. However, for simplicity ad clarity the heating system 22 will be described wherein both the upper electrical heating assembly 22U and the lower electrical heating assembly 22L comprise the respective first upper electrode 54U and the first lower electrode 54L.

Generally, in operation, two or more device plates 74 that when bonded together will yield a single final device 78 or part are stacked and placed on a top surface of the second lower electrode 66L within the vacuum chamber 14 with the press assembly 18 in a Home position. In various instances the second lower electrode 66L can be a graphite electrode. For example, in various embodiments, two or more oscillating heat pipe (OHP) plates having one or more microchannel groove formed in a face of each can be stacked and aligned on the top surface of the second lower electrode 66L such that the microchannel grooves in each of the OHP plates are aligned and will form a corresponding one or more internal microchannel within a single final OHP device that will be produced by bonding (e.g., hermetically bonding) the OHP plates together using the SPB system 10 as described herein. The device plates 74 can be fabricated of any desired material (e.g., aluminum, stainless steel, titanium, ceramic, etc.). In various embodiments, one or more of the device plates 74 can be fabricated of a different material than any one or more of the other device plates 74.

Once the device plates 74 have been stacked on the top surface of the second lower electrode 66L, a front door of the vacuum chamber 14 is closed and sealed and a vacuum is generated within (e.g., all oxygen is removed or evacuated from within) the interior space of the vacuum chamber 14. Subsequently, the stacked device plates 74 are compressed between the upper and lower heating assemblies 22U and 22L, more particularly between the second upper and lower electrodes 66U and 66L. In various embodiments, to compress the stacked device plates 74 between the upper and lower heating assemblies 22U and 22L the upper actuator ram 38 can be moved or lowered in the X⁻ direction (FIG. 2). In various other embodiments, to compress the stacked device plates 74 between the upper and lower heating assemblies 22U and 22L the lower actuator ram 46 can be moved or raised in the X⁺ direction (FIG. 3). In yet other embodiments, to compress the stacked device plates 74 between the upper and lower heating assemblies 22U and 22L the upper actuator ram 38 can be moved or lowered in the X⁻ direction and simultaneously the lower actuator ram 46 can be moved or raised in the X⁺ direction (FIG. 4).

The compression pressure applied to the stacked device plates 74 is regulated, via control of the hydraulic valves 36 and/or the hydraulic valves 42, to a desired specific target compression pressure (for example 10 kN to 25 kN, e.g., 18 kN) that has been scientifically determined to be necessary to bond the stacked plates together when a respective desired specific target electrical current is applied to one or more of the first upper electrode 54U, the second upper electrode 66U, the first lower electrode 54L, and/or the second lower electrode 66L, thereby producing heat (Joule heat) to heat the stacked device plates to a target bonding temperature (for example 400° C. to 700° C., e.g., 520° C. to 580° C.) that has been scientifically determined to be necessary to bond the stacked plates together when the respective desired specific target compression pressure is applied. That is, upon application of the target compression pressure to the stacked device plates, a specific first upper electrode target electrical current is applied to the first upper electrode 54U, and/or a specific second upper electrode target electrical current is applied to the second upper electrode 66U, and/or a specific first lower electrode target electrical current is applied to the first lower electrode 54L, and/or a specific second lower electrode target electrical current is applied to the second lower electrode 66L. Any one or more of the target electrical currents can be the same or all the target currents can be different depending on target compression pressure and various characteristics and parameters of the final device (e.g., size of the final device, thickness of the stacked device plates, the material and material characteristics of stacked device plates, the type and amount of bonding required (e.g., hermetic or non-hermetic bonding), etc.). The target compression pressure, the target electrical current and the target bonding temperature are maintained for a target time duration (for example 15 minutes to 90 minutes, e.g., 30 minutes) that has been scientifically determined to be necessary to bond the stacked plates together when a respective target compression pressure, the target electrical current and the target bonding temperature are maintained.

For example, in various embodiments, the SPB system 10 can be used to hermetically bond together two or more aluminum plates 74 together (e.g., two or more OHP plates 74 having one or more meandering microchannel groove formed in a face of each such that when the aligned and stacked aluminum OHP plates 74 are bonded together the microchannel grooves will form a corresponding one or more internal meandering microchannel within the final OHP device 78), the target compression pressure can be 14 kN to 400 kN, e.g., 18 kN, the target bonding temperature can be 520° C. to 620° C. and the target time duration can be 30 minutes. In such instances, the SPB process occurs above the aluminum solutioning temperature, which will result in a soft T0 temper. To increase the temper of the aluminum final device 78 (e.g., aluminum final OHP device 78), either during or after the SPB process is complete, rapid removal, quenching and aging can provide harder temper, e.g., T4 temper, which allows for subsequent final machining of the resulting final device 78 (e.g., aluminum final OHP device 78).

In various embodiments, the SPB system 10 additionally comprises a hydraulic pump (not shown but clearly understood by one skilled in the art) fluidly connected to the upper hydraulic vales 36 and/or lower hydraulic valves 42, one or more electrical transformer (not shown but clearly understood by one skilled in the art) that is electrically connected to the first and second upper electrodes 54U and 66U and the first and second lower electrodes 54L and 66U via electrical cables 82 and 86, and a vacuum pump (not shown but clearly understood by one skilled in the art). The hydraulic pump is structured and operable to controllably provide hydraulic fluid, via the upper and/or lower hydraulic valves 36 and/or 42, to the upper and/or lower press actuator mechanisms 26 and/or 30 to controllably extend and retract the upper and/or lower actuator rams 38 and/or 46 in the X⁺ and X⁻ direction to thereby controllably apply the target compressing pressure to the stack device plates 74. The electrical transformer(s) is/are structured and operable to controllably provide electrical current to the first and second upper electrodes 54U and 66U and the first and second lower electrodes 54L and 66L, which is then further transferred through the stack device plates 74 to produce heat internally via electrical resistance at the bond interface to the desired target bonding temperature (Joule heating). The vacuum pump is structured and operable to controllably remove or evacuate all oxygen from the interior space of the vacuum chamber 14 after the front door of the vacuum chamber 14 is closed. The SPB system 10 further comprises a control system or control panel 90 that is structured and operable to control the operation of the hydraulic pump, the electrical transformer(s) and the vacuum pump. The control system or panel can be mounted to the vacuum chamber 14 or can be separate remote from vacuum chamber 14. For example, in various embodiments the control panel 90 can comprise a keypad or touch screen integrated into or mounted to the front wall 14A of the vacuum chamber 14. Or, in other embodiments the control panel 90 can be a laptop, tablet, or other computer-based device that wirelessly communicates (e.g., Bluetooth communication) with the hydraulic pump, the electrical transformer(s) and the vacuum pump.

As described above, the upper insulating spacer plate 50U is removably mounted to the distal end of the upper ram 38 (FIGS. 2 and 4) or removably mounted to the upper plate 26 (FIG. 3), and an lower insulating spacer plate 50L removably mounted to the lower plate 30 (FIG. 2) or removably mounted to the distal end of the lower ram 46 (FIGS. 3 and 4). The upper and lower insulating spacer plates 50U and 50L can be fabricated of any thermally insulative material (e.g., carbon fiber composites, graphite felts) suitable to thermally insulate the top plate 26 and/or the bottom plates 30, and/or the upper actuator ram 38 and/or the lower actuator ram 46 from the electrically generated heat (e.g., Joule heat) produced by the respective upper and lower electrical heating assemblies 22U and 22L via application of the target currents to the first and second upper electrodes 54U and 66U and the first and second lower electrodes 54L and 66L. As described above, the first upper and the first lower electrodes 54U and 66U are stacked on and removably mounted to the respective upper insulating spacer plate 50U and lower insulating spacer plate 50L. The first upper and first lower electrodes 54U and 66U can be fabricated of any electrically conductive material that will controllably heat up via controlled application of the respective target electrical current(s). For example, in various embodiments the first upper and first lower electrodes 54U and 66U can be fabricated of brass.

As described above, the upper exchange plate 58U is stacked on and removably mounted to the first upper electrode 54U, the upper CFC shield 62U is stacked on and removably mounted to the upper exchange plate 58U, and the second upper electrode 66U is stacked on and removably mounted to upper CFC shield 62U. The upper exchange plate 58U is structured and operable to removably engage and mount to the first upper electrode 54U in order to facilitate removal of the upper CFC shield 62U and the second upper electrode 66U from the first upper electrode 54U. Similarly, the lower exchange plate 58L is stacked on and removably mounted to the first lower electrode 54L, the lower CFC shield 62L is stacked on and removably mounted to the lower exchange plate 58L, and the second lower electrode 66L is stacked on and removably mounted to lower CFC shield 62L, whereby the lower exchange plate 58L is structured and operable to removably engage and mount to the first lower electrode 54L in order to facilitate removal of the lower CFC shield 62L and the second lower electrode 66L from the first lower electrode 54L. The upper and lower CFC shields 62U and 62L are fabricated of a carbon fiber composite that functions to promote even distribution of the electrically generated heat (e.g., Joule heat) produced by the first upper and lower electrodes 54U and 54L and the second upper and lower electrodes 66U and 66L across the surface of the respective second upper and lower electrodes 66U and 66L that are in physical contact with the stacked device plates 74. Importantly, the even distribution of heat across the surfaces of the second upper and lower electrodes 66U and 66L evenly distributes the heat thermally conducted by the stacked device plates 74. As described above, importantly, the stacked device plates 74 are directly heated via the upper and lower electrical heating assemblies 22U and 22L as opposed to heating the entire interior space of the vacuum chamber 14.

As described above, in various embodiments, the upper electrical heating assembly 22U can comprise an upper cooling tube 70U (e.g., a copper cooling tube) disposed around and/or extending through the upper insulating spacer plate 50U, and the lower electrical heating assembly 22L can comprise a lower cooling tube 70L (e.g., a copper cooling tube) disposed around and/or extending through the lower insulating spacer plate 50L. In such embodiments, the upper and lower cooling tubes 70U and 70L can be hollow tubing that is fluidly connected to a water source (not shown) such that water can be pumped though the upper and lower cooling tubes 70U and 70L to cool the respective upper and lower insulating spacer plates 50U and 50L, and the respective first upper and first lower electrodes 54U and 54L after the device plates 74 have been bonded together to form the final device 78.

The SPB method/process disclosed herein can be used to bond two or more device plates 74 together to achieve hermetically sealed final devices 78 and/or continuous bond line final devices 78 by controlling the three process variables: 1) the target compression pressure; 2) the target bonding temperature, which is controlled by the target electrical current applied to the first and/or second upper and/or lower electrodes 54U and/or 66U and/or 54L and/or 66L; and 3) the target time duration. For example, lower target temperatures (e.g., 400 to 500° C., e.g., 450° C.) can result in mechanically bonded final devices 78 that could be acceptable for heat exchangers, while higher target temperatures (e.g., 520° C. to 620° C.) may be necessary to produce hermetically sealed final devices 78. Ideally, the target time duration is minimized to reduce cycle times (e.g., 10 to 30 minutes), however longer target time durations (e.g., 30 to 90 minutes) can be implemented to achieve the desired bond quality. Preferably, the target compression pressure should be sized to allow for good contact of the device plates 74 interface surfaces (i.e., the surface(s) of each device plate 74 that faces and/or contacts the surface of an adjacent and contiguous device plate 74). For example, in various instances the target compression pressure can be of 10 kN to 400 kN over a desired target temperature range to form a hermetic bond between the device plates 74.

It is envisioned that the SPB method/process of the present disclosure can be utilized to bond together device plates 74 that are formed of metals that are commonly brazed or diffusion bonded together, such as molybdenum, tungsten, titanium, stainless steel, nickel, magnesium, Cu—W, Mo—Cu, and other materials. Furthermore, it is envisioned that generally any device plates 74 can be bonded together using the SPB system 10 and the SPB method described herein to produce generally any final device 78. Particularly, as described above, the SPB system 10 and SPB method described herein can be implemented to bonding together 2 or more stacked OHP device plates 74. For example, the OHP device plates 74 can be aluminum plates having internal microchannels (e.g., microchannels that are <15 mm wide) and interstitial walls between the microchannels (e.g., interstitial walls that are <15 mm wide).

To improve the interdiffusion and increase bond strength of the device plates 74 to each other, in various embodiments a bonding material can be disposed between the interface surfaces of the stacked device plates 74. For example, in various embodiments wherein the SPB system 10 and SPB method are used to produce an aluminum OHP final device 78, brazing alloys, metal, and other bonding agents can be disposed the interface surfaces of stacked aluminum OHP device plates 74.

It is envisioned that rapid quenching in situ and/or subsequent heat treatment of the OHP final device 78 of such exemplary embodiments can be performed to increase the hardness of the OHP final device, having a hardness suitable for subsequent machining of final devices (e.g., a hardness of between 60 HRE and 80 HRE. Additionally, experimentation showed that such exemplary produced OHP final devices 78 were hermetically sealed and leak proof, could undergo subsequent machining with no issues, and could withstand fluid fill and pressure testing with no issues. In various embodiments, the SPB method described herein can additionally include precleaning of the device plates 74, particularly the interface surfaces, to prevent contamination of the interface surface prior to stacking the device plates 74 on top of the lower electrical assembly 22L within the interior space of the vacuum chamber 14. For example, when the device plates 74 are aluminum OHP device plated, the interface surfaces thereof can be preclean using a cleaning solution and/or an abrasive method.

Further to the description of the operation provided above, Spark Plasma Bonding (SPB) is a low voltage, current activated, pressure-assisted technique similar to hot pressing with the added benefit of current heating (Joule heating) which results in much faster processes at lower temperatures. SPB is a derivative of the industry standard Spark Plasma Sintering (SPS), also known as Field Assisted Sintering Technology (FAST), process that is known for rapid material consolidation. SPS is a sintering technique used to fabricate dense and homogeneous bulk materials from powders, while SPB replaces the powders with solid surfaces.

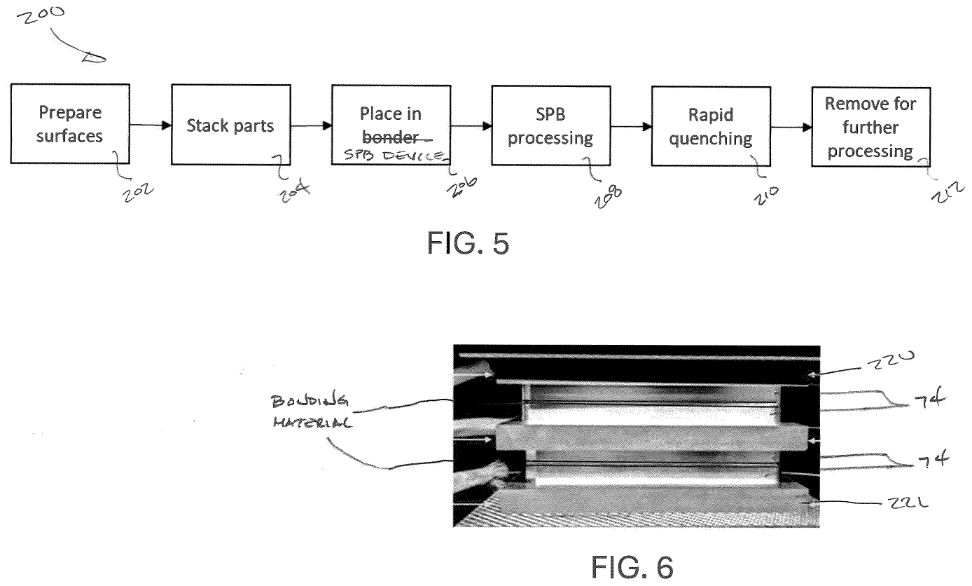

Referring now to FIGS. 1, 2, 3, 4, 5, 6 and 7, it is envisioned that the SPB method/process of the present disclosure can be utilized to bond together device plates 74 that are formed of metals and non-metals. Examples of metals can include those that are commonly brazed or diffusion bonded together, such as molybdenum, tungsten, titanium, stainless steel, nickel, magnesium, copper, Cu—W, Mo—Cu, and other materials. Common non-metals can include ceramics, glasses, polymers and other materials. As exemplarily illustrated in FIG. 5, SPB involves placing the desired parts between the graphite platens (e.g., the second upper and lower electrodes 66U and 66L) and compressing at a set temperature and pressure under a vacuum environment. In various embodiments, the SPB method described herein can include preparing (e.g., precleaning of the device plates 74 of the final device, particularly the interface surfaces, to prevent contamination of the interface surface prior to stacking, as illustrated at 202 of flow chart 200 (FIG. 5). For example, when the device plates 74 are aluminum OHPs, the interface surfaces thereof can be precleaned using a cleaning solution and/or an abrasive method to eliminate or limit oxide layer formation on the interface surfaces. The device plates 74 are then stacked, as illustrated and 204. It is envisioned that generally any device plates 74 can be bonded together using the SPB method described herein to produce generally any final device. Particularly, the SPB method described herein can be implemented to bond together two or more stacked OHP device plates 74. For example, the OHP device plates 74 can be aluminum plates having internal microchannels (e.g., microchannels that are <15 mm wide) and interstitial walls between the microchannels (e.g., interstitial walls that are <15 mm wide), e.g., oscillating heat pipe (OHP) devices. Depending upon the part sizes, graphite or other mold materials may be used to fix the device plates 74. Additionally, multiple layers of units can be processed jointly by stacking layers of device plates 74 with graphite layers in-between to prevent direct bonding between the layers. Stacking is only limited by the working area of the SPB system. A double stacked example shown in FIG. 6. Subsequently, the stacked device plates 74 are placed on the lower electrical heating assembly 22L between the upper and lower heating assemblies 22L and 22U, as illustrated at 206.

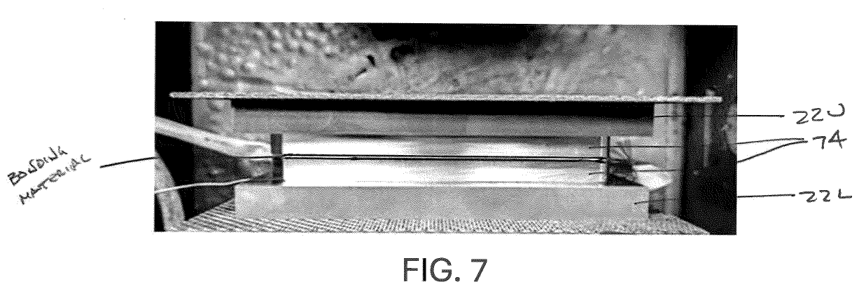

To improve the interdiffusion and increase bond strength of the device plates 74 to each other, in various embodiments a bonding material can be disposed between the interface surfaces of the stacked device plates 74. For example, in various embodiments wherein the SPB method is used to produce an aluminum OHP final device, brazing alloys, metals, and other bonding agents can be disposed between the interface surfaces of stacked aluminum OHP device plates 74. Examples of inserted units are exemplarily illustrated in FIGS. 6 and 7. The device plates 74 of the final device can be manually or robotically inserted into the working area of the vacuum chamber 14. Depending upon the means of SPB system 10 temperature measurement, either thermocouples can be inserted into the graphite platens (e.g., the second upper and lower electrodes 66U and 66L) or measured via the system pyrometer.

In various embodiments, a program with tuned PID settings can be used to adjust the SPB system's 10 response to reach and maintain the desired setpoint (e.g., target temperature), balancing speed (P), steady-state error (I), and overshoot (D) for stability. The following process variables have been scientifically determined to optimize the bonding: 1) the target compression pressure; 2) the target bonding temperature (via current); and 3) the target time duration. These target parameters can be varied in a step-wise manner similar to brazing processes. As illustrated in at 208, once the device plates 74 have been stacked and inserted into the vacuum chamber 14, a front door of the vacuum chamber is closed sealing the vacuum chamber 14, and a vacuum is generated within (e.g., all oxygen is removed or evacuated from within) the interior space of the vacuum chamber 14. Alternatively, a partial pressure of an inert gas can be employed. Subsequently, the stacked device plates 74 are compressed between the upper and lower electrical heating assemblies 22U and 22L via the press actuator mechanism 34 (e.g., a hydraulic ram). The compression pressure applied to the stacked device plates 74 is regulated, via control of the hydraulic valves 36, to a desired specific target compression pressure that has been scientifically determined to be necessary to bond the stacked plates 74 together when a respective desired specific target temperature and time have been applied. As described above, in various instances, once the plates 74 have been bonded, in various instances rapid quenching in situ and/or subsequent to the bonding of the OHP final device 78, as illustrated at 210. The quenching can increase the hardness of the OHP final device, having a hardness suitable for subsequent machining of final devices (e.g., a hardness of between 60 HRE and 80 HRE. Thereafter, the bonded final device is removed from any further processing, as indicated at 212.

The SPB method/process disclosed herein can be used to bond two or more device plates 74 together to achieve hermetically sealed final devices and/or continuous bond line final devices. For example, lower target temperatures (e.g., 400° C. to 500° C.) can result in mechanically bonded final devices that could be acceptable for heat exchangers, while higher target temperatures (e.g., 520° C. to 620° C.) are necessary to produce hermetically sealed final devices. Ideally, the target time duration is minimized to reduce cycle times (e.g., 10 to 30 minutes), however longer target time durations (e.g., 30 to 90 minutes) can be implemented to achieve the desired bond quality. In various instances, the target compression pressure should be sized to allow for good contact of the device plates 74 interface surfaces (i.e., the surface(s) of each device plate 74 that faces and/or contacts the surface of an adjacent and contiguous device plates 74). For example, in various instances the target compression pressure can be 10 kN to 400 kN over a desired target temperature range to form a hermetic bond between the device plates 74.

In such instances, the SPB process occurs above the aluminum solutioning temperature, which will result in a soft T0 temper. To increase the temper of the aluminum final device, rapid quenching and aging can provide harder temper, e.g., T4 temper, which allows for subsequent final machining of the resulting final device (e.g., aluminum final OHP device).

Experimentation has shown that OHP final devices produced via the SPB system 10 and method/process described herein were hermetically sealed and leak proof, could undergo subsequent machining with no issues, and could withstand fluid fill and pressure testing with no issues.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A method of bonding two or more substrates, said method comprising:
placing two or more substrates in a vacuum chamber, the substrates having facing interface surfaces;
generating a vacuum in the vacuum chamber;
compressing the substrates between opposing electrodes of a spark plasma bonding system to apply a target compression pressure;
applying electrical current through the substrates via the electrodes to generate localized Joule heating; and
maintaining the target compression pressure, a target bonding temperature for a target time duration sufficient to effect bonding between the substrates.

2. The method of claim 1, wherein the substrates are oscillating heat pipe plates and wherein the bonding produces a hermetically sealed oscillating heat pipe device.

3. The method of claim 1, wherein:
the target compression pressure is between 10 kilonewtons and 25 kilonewtons;
the target bonding temperature is between 500° C. and 600° C.; and
the target time duration is between 20 minutes and 40 minutes.

4. The method of claim 1, further comprising disposing a bonding interlayer between interface surfaces.

5. The method of claim 1, further comprising, after bonding, rapidly quenching the bonded device and aging the bonded device to increase temper of the aluminum to enable subsequent machining.

6. The method of claim 1, further comprising, prior to placing the substrates in the vacuum chamber, precleaning the interface surfaces.

7. A spark plasma bonding system for bonding two or more substrates, the system comprising:
a vacuum chamber configured to maintain an oxygen-free environment;
a high-pressure press assembly disposed within the vacuum chamber, the press assembly configured to apply a compression pressure to the two or more substrates; and
a Joule heating system operably connected to the press assembly, the Joule heating system comprising opposing upper and lower electrodes configured to receive the substrates therebetween and to pass an electrical current through the substrates to generate Joule heating.

8. The system of claim 7, wherein the high-pressure press assembly comprises:
an upper plate and a lower plate fixed within the vacuum chamber; and
at least one press actuator mechanism comprising an actuator ram configured to move one of the upper or lower electrodes toward the other to apply the compression pressure.

9. The system of claim 7, wherein the spark plasma electrical heating system comprises an upper electrical heating assembly and a lower electrical heating assembly, each assembly comprising a stacked arrangement of:
an insulating spacer plate;
a first electrode removably mounted to the insulating spacer plate;
a carbon fiber composite (CFC) shield stacked on the first electrode; and
a second electrode stacked on the CFC shield, wherein the second electrode is configured to be in physical contact with one of the substrates.

10. The system of claim 9, wherein the first electrode is a brass electrode and the second electrode is a graphite electrode.

11. The system of claim 9, wherein the CFC shield is configured to promote an even distribution of heat generated by the electrodes across a surface of the second electrode.
